(19) United States
(12) Patent Application Publication
(10) Pub. No.: US 2006/0225022 A1
(43) Pub. Date: Oct. 5, 2006

(54) Method, apparatus and program for determining the relationship of correspondence between register transfer level description and behavioral description

(75) Inventor: Takahide Ezaki, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/395,210

(22) Filed: Apr. 3, 2006

(30) Foreign Application Priority Data
Apr. 4, 2005 (JP) 2005-107817

(51) Int. Cl. G06F 17/50

(52) U.S. Cl. 716/18

(57) ABSTRACT

The relationship of correspondence between the RTL description and the behavioral description is extracted with ease. A behavioral synthesis device analyzes how the scheduling, preparation of a control data flow graph and the sharing of arithmetic processing units and registers are carried out. The behavioral synthesis device then formulates a table of correspondence to show the relationship of correspondence between the RTL description and the CDFG and a table of correspondence to show the relationship of correspondence between the CDFG and the behavioral description. A path determining device couples these tables of correspondence to generate a table of correspondence determining the relationship of correspondence between the RTL description and the behavioral description. The path determining device reflects a path of interest in the RTL description. The path determining device then outputs the behavioral description, corresponding to the RTL description, so that the behavioral description will be uniquely determined by the states of the FSM possessed by the RTL description and by the conditional branching in the behavioral description.

### FIELD OF THE INVENTION

This invention relates to a method, an apparatus and a program for determining upstream side description corresponding to a path of a semiconductor integrated circuit. More particularly, this invention relates to a method for determining the relationship of correspondence between the register transfer level description and the behavioral description, and an apparatus and a program for executing the method.

### BACKGROUND OF THE INVENTION

The degree of integration of LSI is increasing exponentially from year to year. However, since there is naturally a limitation to the ability of an individual designer, there may be presented a situation that the designing capability cannot catch up with the increase in designing task size. Among the effective approaches to breakthrough of the crisis in design productivity, there is a method for raising the level of abstraction of designing, and a variety of EDA (Electronic Design Automation) tools have so far been proposed to implement this method.

For example, in designing the hardware for executing certain processing, so-called behavioral synthesis, also termed high-level synthesis or functional synthesis, may be used to raise the level of abstraction in the designing. This behavioral synthesis automatically synthesizes the Register Transfer Level description, abbreviated below to RTL description, which takes account of the concept proper to hardware, such as registers or synchronization by clocks, from the behavioral description, which directly describes the algorithm of the processing of interest by the behavioral level.

The schematics of the behavioral description will now be described by taking a concrete example. FIG. 2 shows the behavioral description, and FIG. 3 shows the configuration of the RTL description, synthesized from the behavioral description, and which is made up of data paths 21 for executing the arithmetic processing and an FSM (Finite State Machine) 22 for controlling the states. The arithmetic units, registers and input/output terminals, shown in FIG. 3 by way of examples, are termed nodes, and a sketch shown as a circuit diagram composed of these nodes is termed RTL description. Also, the state means the state controlled by the FSM, and conditional branches, sometimes referred to below simply as conditions, correspond to selectors of the data paths.

In the behavioral synthesis, a conversion process in which the processing described on the behavioral level is carried out in plural separate states, so as to satisfy the synthesis constraints, such as operating frequencies, determining the delay between the registers or between the input/output terminals and the registers, or the sorts and/or the number of the hardware resources, such as arithmetic processing units or registers. As a process for transformations from the behavioral description to the RTL description, a string of arithmetic processing operations, that is, the flow of data and control, is extracted from the behavioral specification in the logical designing from the behavioral specification. Then, scheduling is carried out to generate a Control Data Flow Graph (CDFG), shown in FIG. 4. Finally, various circuit components are allocated to the arithmetic processing operations, based on the control data flow graph, to synthesize a logic circuit (see Non-Patent Document 1).

In Patent Document 1, there is disclosed a technique consisting in analyzing the relationship of mutual exclusiveness of hardware resources, such as arithmetic processing units or registers, and sharing those resources which are in the relationship of mutual exclusiveness. FIG. 4 depicts an example of a control data flow graph associated with the behavioral description of FIG. 2. Specifically, FIG. 4 shows a case where, as a result of scheduling the behavioral description of FIG. 2, under specified synthesis constraints, the configuration composed of two states (states 1 and 2) is obtained. Referring to FIG. 4, multiplications 1, 2 and 3 belong to different states or conditions, so that these are in the relationship of mutual exclusiveness and hence may share the same resources. In other words, according to the behavioral description of FIG. 2, the multiplication of row 14, equivalent to the multiplication 3 of FIG. 4, belongs to state 2 different from the state of the multiplication of row 8 (equivalent to multiplication 1 of FIG. 4) or to the state of the multiplication of row 11 (equivalent to multiplication 2 of FIG. 4). The multiplication at row 8 and that at row 11 belong to the same state (state 1), however, the multiplication of row 8 is carried out under a condition s>10 (condition 1), whilst that of row 11 is carried out under a condition different from the condition other than s>10, that is, under a condition 2. That is, these multiplications belong to different conditions. Thus, in the RTL description, a sole multiplier may be shared by these multiplications, that is, the multiplications may be expressed by the sole multiplier.

FIG. 3 shows the configuration of the RTL description, generated on the basis of the above consideration. Referring to FIG. 3, the multiplications at rows 8, 11 and 14 in the behavioral description of FIG. 2 are allocated, by the behavioral synthesis, to a sole multiplier (multiplier 1 in a data path 21 indicated on the left hand side of FIG. 3).

The RTL description, obtained by the above synthesis, is then transformed, by logical synthesis, into the gate-level description including the information on the delay between registers or between the input/output terminal and the registers. This gate-level description, which is a gate-level logic circuit or a netlist, is referred to below simply as “gate description”. At this stage, static timing analysis is carried out, and the circuit delay information, referred to below as “timing report”, is checked to verify whether or not the circuit data of the gate description meets the synthesis constraint, such as delay or area. In case the delay is not in meeting with design conditions, or in case the delay is in meeting with the design conditions but there is not sufficient allowance for delay, it becomes necessary to improve the design by reducing the delay of the path having the maximum delay in the circuit, referred to below as “critical path”. However, to this end, it may become necessary to correct the original behavioral description.

In this case, it is necessary to specify to which part of the behavioral description corresponds a given path in the gate description, in particular the critical path. However, the gate description is circuit data obtained through two stages of automatic syntheses, namely the behavioral synthesis and the logical synthesis, and hence is vitally different from the original behavioral description. The gate description is therefore difficult to understand for a designer, and hence the critical path in the behavioral description may only be determined by a time-consuming operation.

Patent Document 2 is directed to providing a solution to this problem, and shows a method for correlating the circuit delay information in a timing report to the gate description. According to this Patent Document, an FPGA designing system initially formulates a path circuit configuration demonstrating report by transforming the circuit configuration following placement and routing and a timing report for this circuit into a circuit configuration employing cell names and net names of the gate description as design data (step S307 of FIG. 2 of Patent Document 2). For example, a timing report including logical block coordinates, net names, delay time, instance names of logical blocks and instance names of cells included in the logical blocks, as shown in FIG. 4 of Patent Document 2, is transformed into a path circuit configuration demonstrating report, including instance names of cells, net names, cell names, delay time, placement coordinates of logical blocks, and input/output pins of cells, as shown in FIG. 5 of Patent Document 2.

According to Patent Document 2, the FPGA designing system then formulates image data in graphical representation, as the gate description is correlated with the circuit configuration subsequent to the placement and routing, based on the path circuit configuration demonstrating report, for demonstration on the input/output terminal device (step S308). By this processing, the circuit configuration of the path including specified cells or nets, may be demonstrated as the gate description is correlated to the circuit configuration, subsequent to the placement and routing, as obtained from the timing report. Hence, it becomes possible to retrieve and grasp to which part of the gate description corresponds a path on the timing report.

[Patent Document 1]

JP Patent Kokai Publication No. JP-A-5-334466

[Patent Document 2]

JP Patent Kokai Publication No. JP-P2002-366597A

[Non-Patent Document 1]

The High-Level Synthesis of Digital Systems: MICHAEL C. McFARLAND, ALICE C. PARKER, RAUL CAMPOSANO: Proceedings of the IEEE, Vol. 78, No. 2, February, 1990

The entire disclosure of these documents are incorporated herein by reference thereto, which may be subject to further incorporation, upon necessity, as part of the disclosure of the present invention as set forth below.

### SUMMARY OF THE DISCLOSURE

With the teaching of the above Patent Document 2, it is possible to correlate the critical path with the gate description. However, the gate description is generated automatically through logical synthesis and behavioral synthesis, as described above, with the description volume of the gate description being sometimes as large as several times to tens of times that of the behavioral description. Thus, even with the teaching of Patent Document 2, the designer has to perform the work of understanding and changing the gate description, by pain-taking and time-consuming working, in order to improve the critical path.

It may be contemplated to correct not the gate description but the behavioral description, originally formulated by the designer, and to carry out the behavioral description and the logical synthesis again. However, in such case, it is necessary to analyze to which part of the behavioral description a path in the gate description corresponds, that is, to obtain the relationship of correspondence between the gate description and the behavioral description.

In general, this relationship of correspondence between the gate description and the RTL description may roughly be understood from, for example, the signal names in the circuit description. For example, a logical synthesis tool ‘Sinplify’ by SYNPLICITY Inc. has the function of analyzing and demonstrating the relationship of correspondence between the gate description and the RTL description to provide an environment under which the relationship of correspondence between the two descriptions may be searched with relative ease.

It is, however, difficult to obtain such relationship of correspondence between the RTL description and the behavioral description. One of the reasons is that, due to a demand for sharing the resources, as entailed by the synthesis constraint, a sole arithmetic processing unit or a register in the RTL description is associated with plural arithmetic processing units or variables in the behavioral description. In such case, the one-to-multiplicity relationship exists between the RTL description and the behavioral description.

In taking the relationship of correspondence between a path in the RTL description, generated by the behavioral synthesis, and a path in the behavioral description, it becomes necessary to analyze how the behavioral synthesis has carried out scheduling, preparation of control data flow graph and sharing of the arithmetic processing units or registers, as described above. However, this analysis operation is again carried out by a time-consuming manual operation.

It is therefore there is much desired in the art to provide a novel method, a novel apparatus and a novel program having an improved operation. Particularly it is much desired to provide an improvement wherein the relationship of correspondence between the register transfer level description and the behavioral description may be determined without the laborious time-consuming manual operation.

The objects and advantages of the present invention will become apparent from the entire disclosure including the appended claims and drawings.

In a first aspect, the present invention provides a method for determining the relationship of correspondence between the register transfer level description and the behavioral description. The method is carried out using a behavioral synthesis device for generating, from the behavioral description and the synthesis constraint, the register transfer level description including the state of a finite state machine, and also using a circuit designing assisting device. At the time of the behavioral synthesis, a table of correspondence, providing the relationship of correspondence between the register transfer level (RTL) description including the state(s) of a finite state machine and the behavioral description, is formulated, using the intermediate information. The circuit designing assisting device outputs a path or paths so that meaningful site or sites of the path(s) of the behavioral description will be uniquely determined, based on the state(s) of the finite state machine and on the conditional branch sentences contained in the behavioral description. Specifically, the behavioral synthesis device formulates a table of correspondence, showing the relationship of correspondence among the parent side description (behavioral description), child side description (register transfer level description), the states of the finite state machine of the RTL description and conditional branching included in the behavioral description, using the information obtained in the process of the scheduling, preparation of the control data flow graph and the sharing of the arithmetic processing units and the registers. The circuit designing assisting device then outputs the relationship of correspondence between the RTL description and the behavioral description in such a manner as to enable the relationship of correspondence to be uniquely determined, using the above table of correspondence, based on the states of the finite state machine of the RTL description and on the information contained in the behavioral description.

In a second aspect, the present invention provides a behavioral synthesis device and a circuit designing assisting device for carrying out the above method. The behavioral synthesis device includes relationship of correspondence storage means for storing and holding the relationship of correspondence that exists in the process of generating the register transfer level description among the parent side description (behavioral description), child side description (register transfer level description), the state(s) of the finite state machine of the of the RTL description and the conditional branching, included in the behavioral description. The behavioral synthesis device further includes table of correspondence generating means for generating a table of correspondence showing the relationship of correspondence among at least child side description (register transfer level description), the states of the finite state machine of the RTL description, the conditional branching included in the behavioral description, and the parent side description (behavioral description), using the information stored and held in the relationship of correspondence storage means. The circuit designing assisting device includes correspondence determining means receiving the table of coincidence from the behavioral synthesis device and outputting the relationship of correspondence between the register transfer level description and the behavioral description so that the relationship of correspondence will be uniquely determined based on, the states of the finite state machine possessed by the register transfer level description and on the information of the conditional branching possessed by the behavioral description.

The behavioral synthesis device and the circuit designing assisting device, having the aforementioned respective means, may be implemented by a program executed by an information processing apparatus, such as a personal computer or work station. The present invention also provides the program running on computers constituting the aforementioned devices. This program is furnished in a form recorded on a computer readable recording medium, such as magnetic disc. The program is read in by the computer to control its operation so that respective functional means or units in the behavioral synthesis device or system and in the circuit designing assisting device or system will be implemented on the computers.

The meritorious effects of the present invention are summarized as follows.

According to the present invention, the LSI is improved in design productivity, while the circuit logic verification or simulation may be improved in efficiency. The reason is that the operations up to the ‘analysis of states and conditions’, which heretofore was necessarily carried out by manual operations, may be automated, and means are provided for retrospectively specifying a path from the gate level description to the behavioral description.

### BRIEF DESCRIPTION OF THE DRAWINGS

FIG. 1 shows the configuration and the processing flow of a first embodiment of the present invention.

FIG. 2 illustrates an example of the behavioral description.

FIG. 3 is a diagram showing an example of the RTL description (register transfer level description) corresponding to the behavioral description of FIG. 2.

FIG. 4 is a diagram showing an example of a CDFG (control data flow graph) corresponding to the behavioral description of FIG. 2.

FIG. 5 is a diagrammatic view showing a table of correspondence (first table of correspondence) generated in the first embodiment of the present invention.

FIG. 6 is a diagrammatic view showing a table of correspondence (second table of correspondence) generated in the first embodiment of the present invention.

FIG. 7 is a diagrammatic view showing a table of correspondence (third table of correspondence) generated in the first embodiment of the present invention.

FIG. 8 shows a path in the RTL description by plural nodes.

FIG. 9 is a diagrammatic view showing behavioral description corresponding to the path in the RTL description of FIG. 8, in which the behavioral description has been determined.

FIG. 10 is a diagrammatic view showing a table of correspondence (first table of correspondence) generated in a second embodiment of the present invention.

FIG. 11 is a diagrammatic view showing a table of correspondence (second table of correspondence) generated in the second embodiment of the present invention.

FIG. 12 is a diagrammatic view showing a table of correspondence (third table of correspondence) generated in the second embodiment of the present invention.

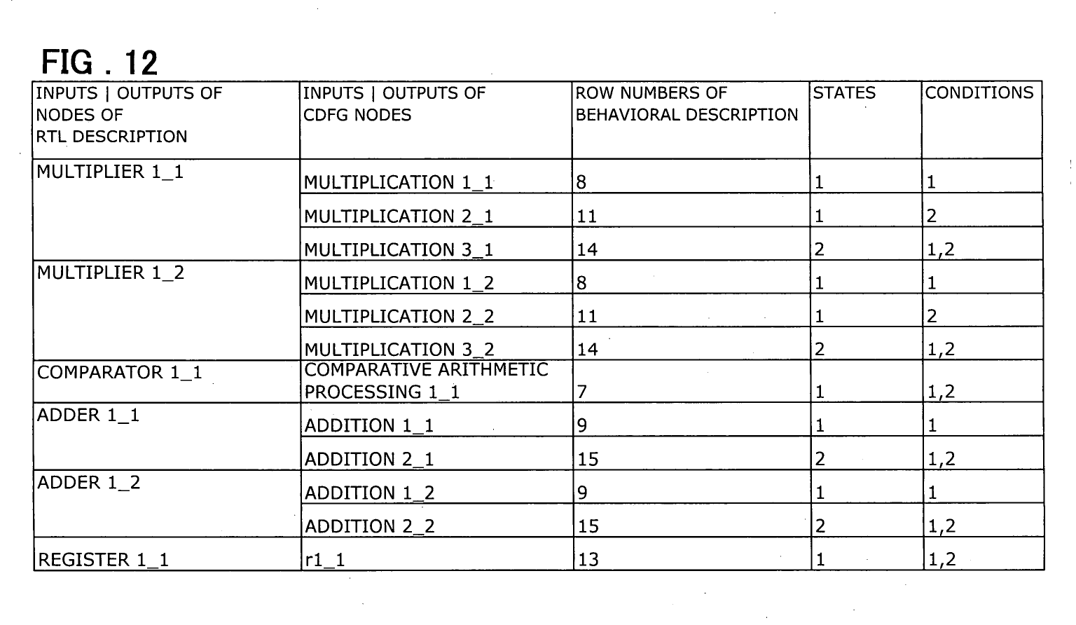

FIG. 13 shows a path in the RTL description by input/output from nodes.

FIG. 14 is a diagrammatic view showing behavioral description corresponding to the path in the RTL description of FIG. 13, in which the behavioral description has been determined.

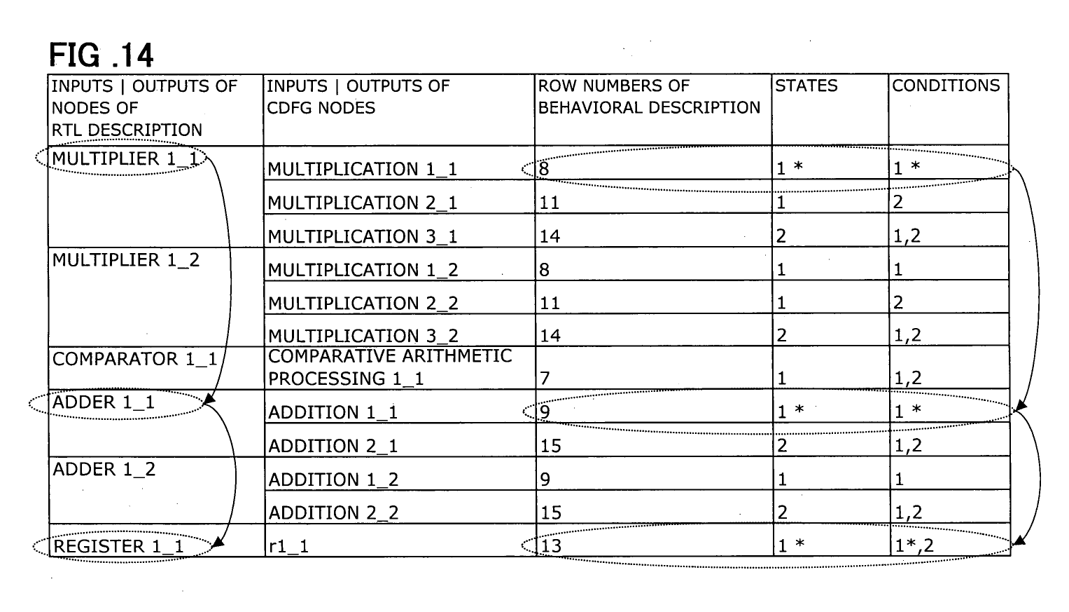

### PREFERRED EMBODIMENTS OF THE INVENTION

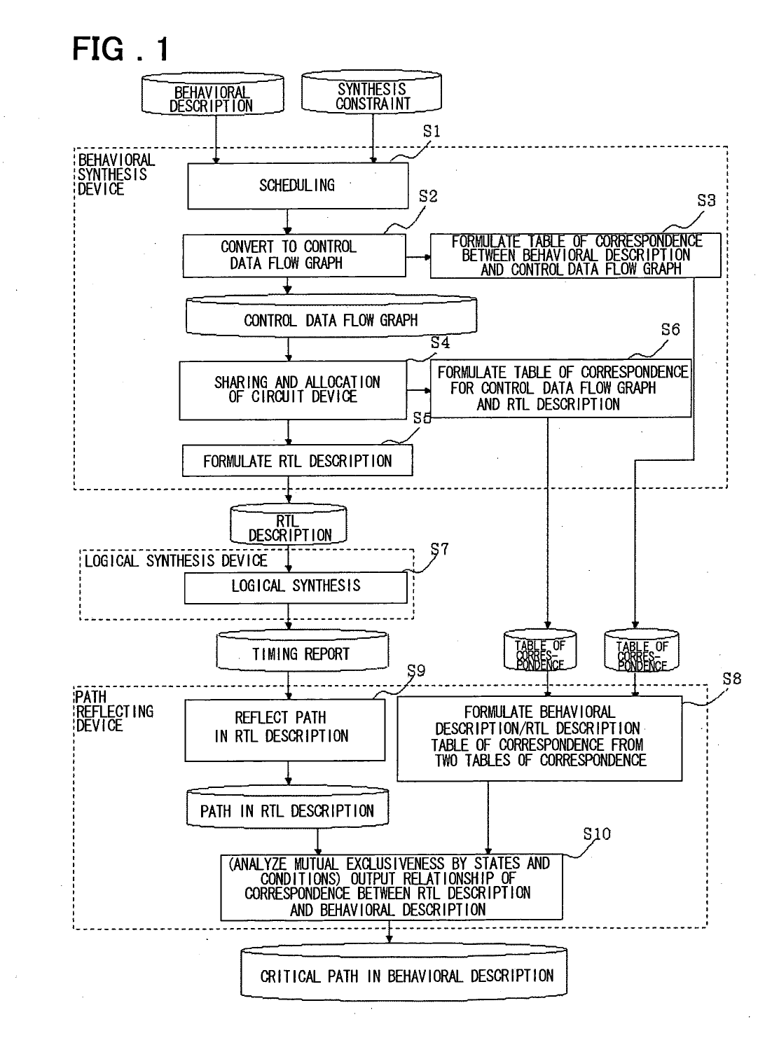

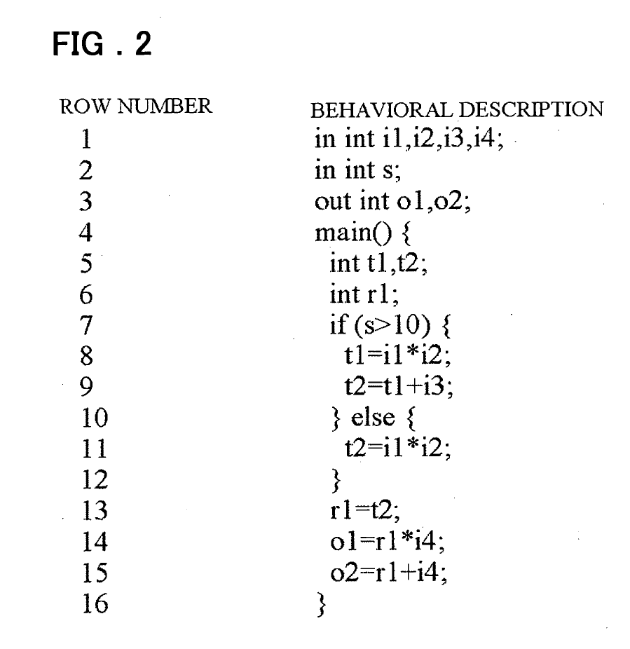

Preferred modes for carrying out the present invention will now be described with reference to the drawings. FIG. 1 shows various devices used in the present embodiment and the processing flow carried out by the respective devices. Referring to FIG. 1, the present embodiment is configured for using a behavioral synthesis device, a logical synthesis device and a path reflecting device (circuit designing assisting device), these devices being indicated by frames of dotted rows in the drawing. In the following, an embodiment of the present invention in which a path for behavioral description is determined from a path on a timing report obtained by timing analysis will be described. The timing analysis is carried out on a circuit of the gate description which is obtained by behavioral synthesis and logical synthesis based on the behavioral description already described with reference to FIG. 2.

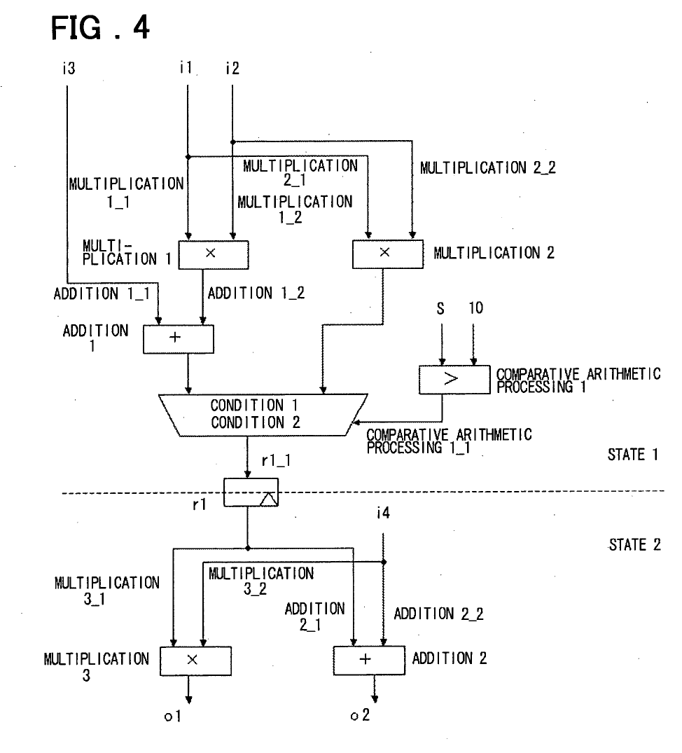

Initially, the behavioral synthesis device analyzes the behavioral description shown for example in FIG. 2, and decides on the sequence of execution of arithmetic processing units, based on the operating frequency or on synthesis constraints, such as the sorts (types) or the number of hardware resources, for example, arithmetic processing units or registers, by way of carrying out the scheduling (step S1). In this manner, the behavioral synthesis device converts the behavioral description into a control data flow diagram (CDFD), having the configuration of two states (state 1 and state 2) shown in FIG. 4, as an intermediate level description (internal description) (step S2). Each time the behavioral synthesis device generates a node of the CDFG, such as arithmetic operating unit, register or an input/output terminal, the behavioral synthesis device records the corresponding behavioral description, state(s) and the condition(s).

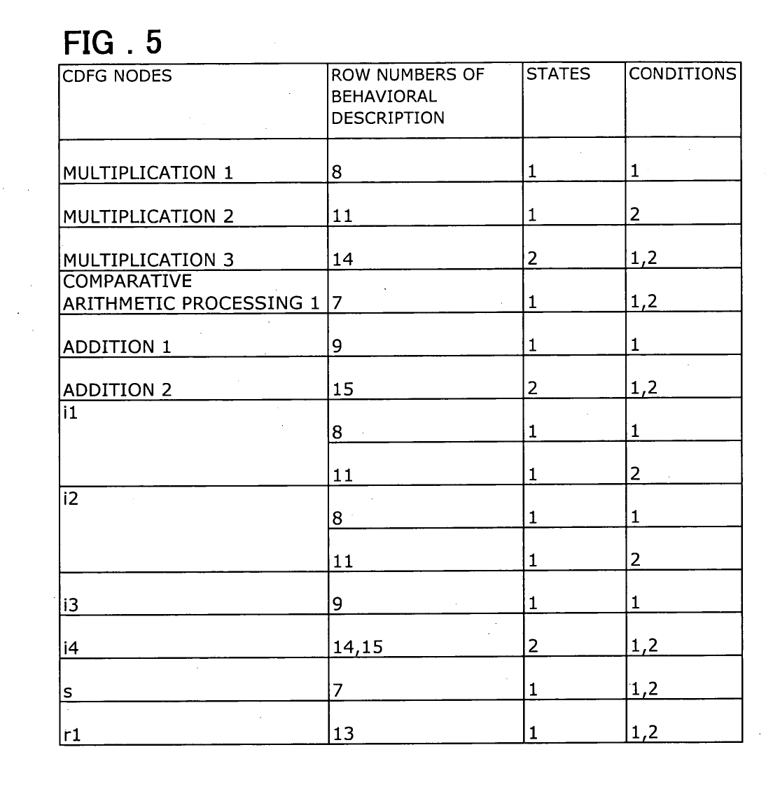

As a result, a table of correspondence (first table of correspondence) showing the relationship of correspondence between nodes of the CDFG (arithmetic operating units, registers or input/output terminals) on one hand, and the numbers of rows, states and the conditions of the behavioral description, on the other hand, is formulated (step S3). In the table of correspondence, shown in FIG. 5, it is shown that the multiplication 1 is carried out only in case the state is 1 and the arithmetic processing operation for comparison s>10 is true, that is, the condition is the condition 1. It is also shown that the multiplication 3 is carried out only in case the state is at 2 and either the condition is the condition is 1 or the operation for comparison s>10 is false, that is, the condition is at 2.

The behavioral synthesis device then formulates RTL description (step S5) from the CDFG in accordance with the sequence of general behavioral synthesis, as the behavioral synthesis device generates FSM controlling the circuit behavior based on the states owned by the CDFG, performs co-possessing (sharing) of hardware resources, such as arithmetic operating unit(s), based on the synthesis constraints, and allocates circuit device(s) (step S4). In the process of the above step S3, the behavioral synthesis device again records the states and the conditions prevailing each time it connects a node of the RTL description to a CDFL node.

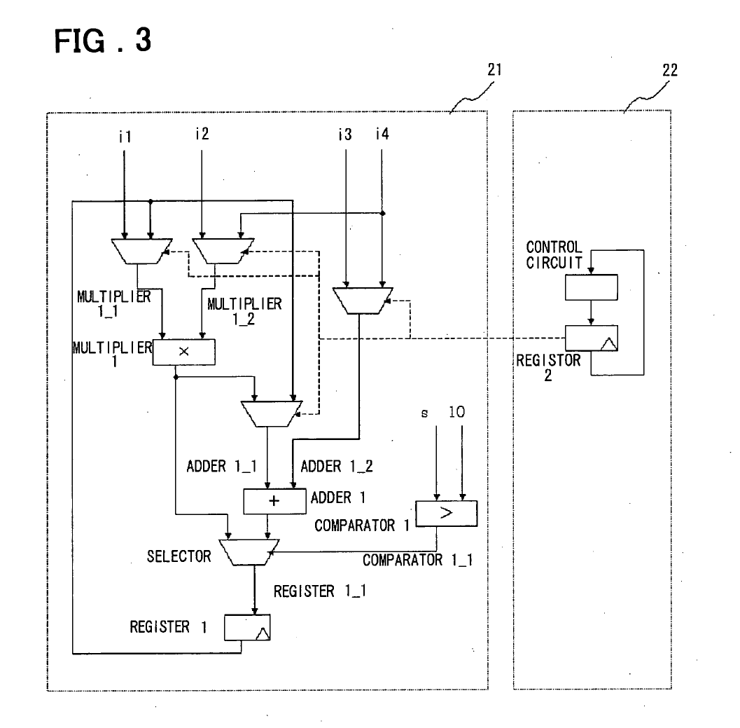

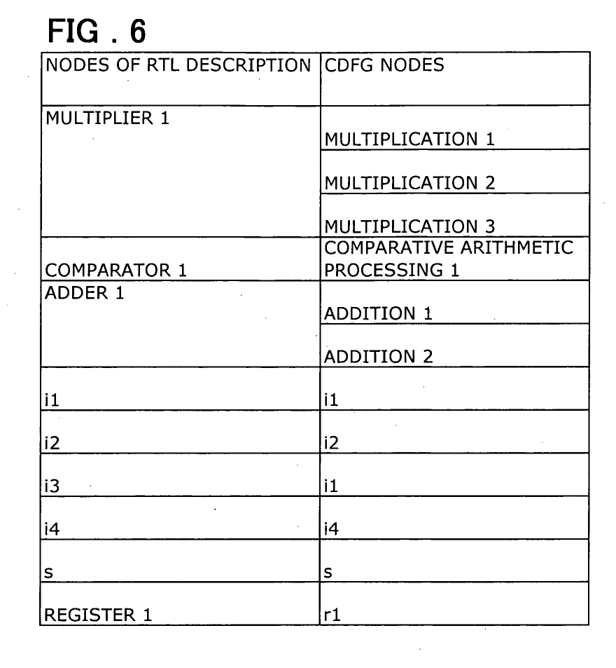

If, as a result, the RTL description, having the configuration as shown for example in FIG. 3, is obtained, a table of correspondence showing the relationship of correspondence between the nodes of the RTL description and those of the CDFL (second table of correspondence) shown in FIG. 6 is generated (step S6).

The RTL description, generated in the above step S5, is then converted into the gate description by logical synthesis carried out by the logical synthesis device, and a timing report is output (step S7). This timing report, not described in detail herein, is obtained by applying the technique of general static timing analysis to the gate description, obtained by logical synthesis of the aforementioned RTL description, and hence is not of a problem.

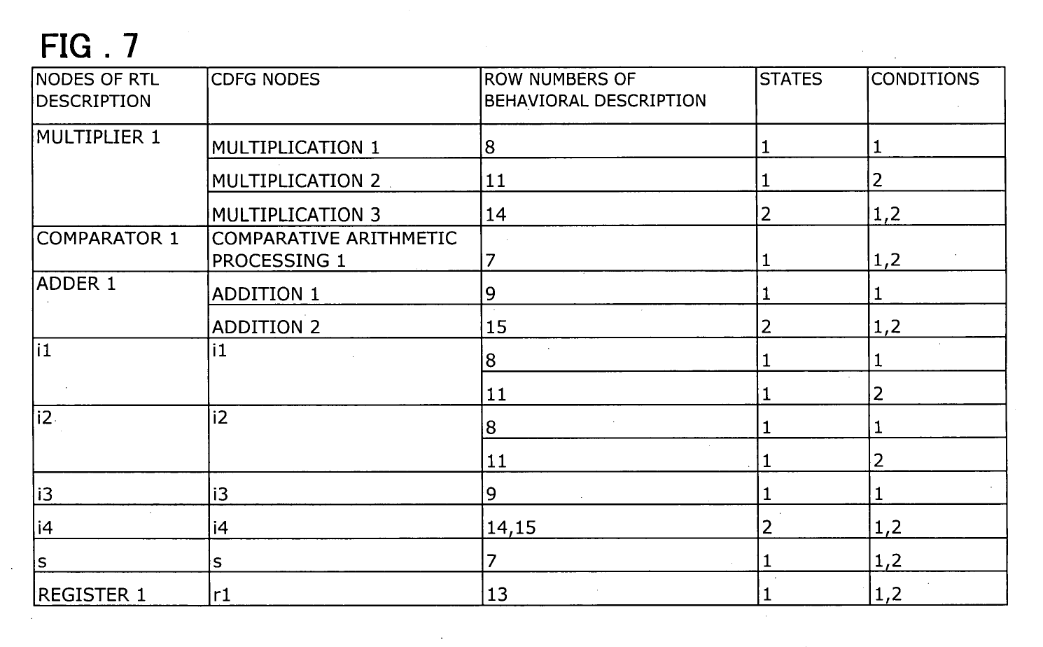

The timing report and data of the first and second tables of correspondence, obtained at this moment, are entered on-row or via a recording medium to a path reflecting device (circuit designing assisting device) where subsequent processing is executed. This path reflecting device (circuit designing assisting device) connects the first and second tables of correspondence, with the CDFG nodes as a connecting key, to prepare a table of correspondence shown in FIG. 7 (third table of correspondence) (step S8).

The path reflecting device (circuit designing assisting device) then performs static timing analysis and, from the timing report, thereby obtained, acquires the path information in the gate description. Then using the methods described above in the background art, or an EDA tool, the path reflecting device acquires the paths of the RTL description (step S9).

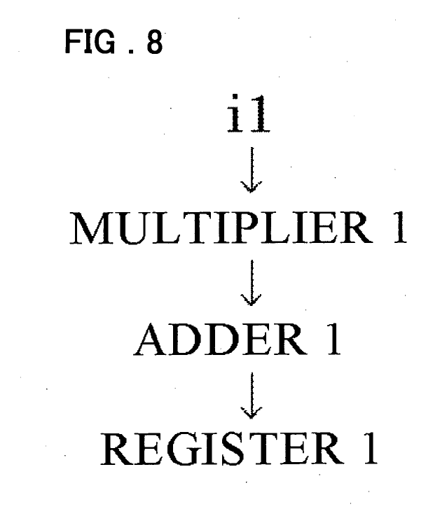

FIG. 8 shows an example of such a path of the RTL description, generated in the above step S9. It is seen from FIG. 7 that, as for the register 1, located at the trailing end of the path of the RTL description, the RTL description and the behavioral description are in one-to-one correspondence with each other. Hence, the corresponding site in the behavioral description (row 13) can be determined uniquely. However, an input terminal i1 of the RTL description corresponds to rows 8 and 11 of the behavioral description, a multiplier 1 corresponds to rows 8, 11 and 14 of the behavioral description and an adder 1 in the RTL description corresponds to rows 9 and 15 of the behavioral description. Hence, none of the sites (nodes) of the input terminal, multiplication and the addition can be uniquely determined in the behavioral description.

In such case, the corresponding sites of the behavioral description can be determined, by a process of elimination, subject to ‘analysis of the states and the conditions’, which will now be described briefly. Insofar as the circuit behavior is concerned, a path belonging to the state 1, from the input i1 to the register r1, and a path belonging to the state 2, from the register r1 to an output o2, are both meaningful paths in the example shown in FIG. 4. These are paths belonging to a sole state (state 1 or 2) in the CDFG. If attention is directed to this fact, it will be understood that respective nodes, such as arithmetic processing units, in a given path, must belong to the same state.

If the present case is considered in the light of the foregoing, it is seen from the “state” column of the table of correspondence of FIG. 7 (third table of correspondence) that all of the input terminal i1, comparator 1 and the register 1 belong to the state 1 only. Hence, the multiplier 1 of the path of FIG. 8 has no meaning except if it belongs to the state 1. Consequently, the multiplication 1 of the behavioral description, belonging to the state 1, is the multiplication at row 8 and the multiplication 2 at row 11. That is, either the multiplication at the row 8 or the multiplication at the row 11 corresponds to the multiplier 1 of the path of FIG. 8. In similar manner, as for the adder 1, the addition 1 at row 9 of the behavioral description corresponds to the adder 1 of the path of FIG. 8.

Attention is now directed to the conditions to which the nodes on the path belong. The nodes on a path which is meaningful in light of the circuit behavior must all belong to the same condition, as is the case with the states. If the present embodiment is considered in light of this, the addition 1 at row 9 of the behavioral description, arrived at by the process of elimination in the state analysis, belongs only to the condition 1. Therefore, the other nodes also must belong to the condition 1. If attention is directed to multiplication 1 at row 8 and to multiplication 2 at row 11 of the behavioral description, only the multiplication 1 at row 8 corresponds to the condition 1. From this it is apparent that the behavioral description corresponding to the multiplier 1 of the path of FIG. 8 is the multiplication 1 at row 8.

In similar manner, if attention is directed to the input at row 8 and to the input i1 at row 11 in the behavioral description, only the input i1 at row 8 belongs to the condition 1. It may therefore be seen that the input i1 of the behavioral description, corresponding to the input terminal i1 of the path of FIG. 8, is the input i1 at row 8.

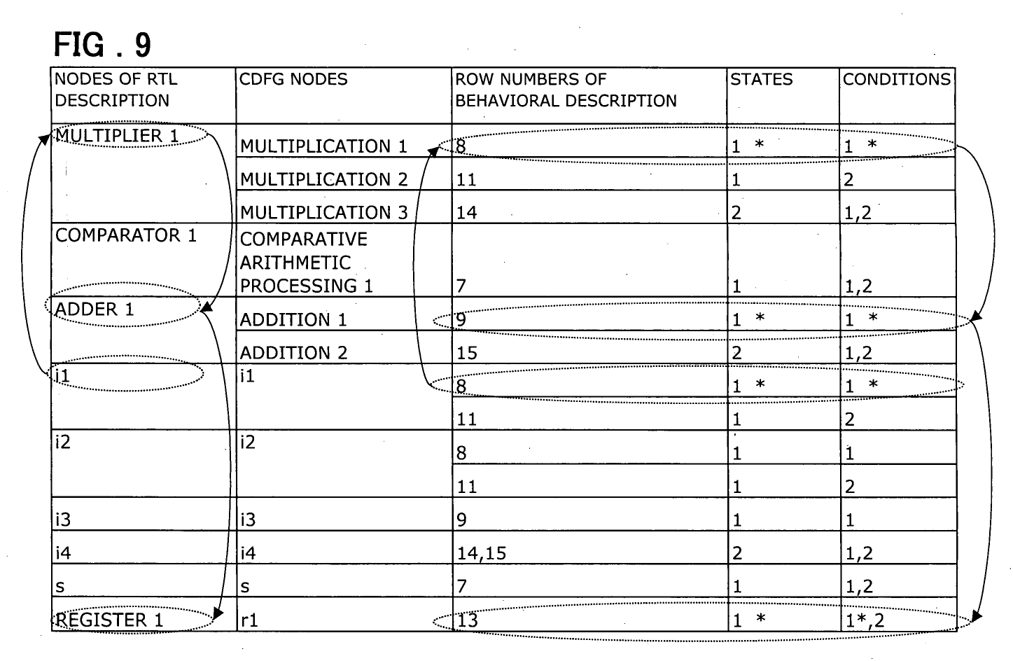

Thus, by carrying out the ‘analysis of states and conditions’ in step S10 of FIG. 1, the sites of the behavioral description, corresponding to the path of FIG. 8, may be determined, as shown in FIG. 9. In addition, the above sequence of operations may be automated to facilitate the determination of the paths on the RTL description on the behavioral description.

It is seen from above that, by preparing, in the process of behavioral synthesis, the table of correspondence between the nodes of the RTL description, the behavioral description and the states as well as the conditions (third table of correspondence of FIG. 7), and by taking account of the fact that the path meaningful from the perspective of the circuit behavior must belong to the same state and to the same condition, the arithmetic operations or variables, belonging to different states or conditions, may be excluded from the arithmetic operations or variables in the behavioral description that are likely to reside on a path of interest. Moreover, by additionally automating a decision as to whether a given path is meaningful from the perspective of circuit behavior, it is possible to automate the analysis of the relationship of correspondence between the RTL description and the behavioral description. This appreciably contributes to improving the productivity in designing. Furthermore, the principle of the present invention proves an effective tool in logical circuit verification or simulation to save the manpower significantly.

It should be noted that, in the above embodiment, static timing analysis is carried out on the gate description, obtained by logical synthesis of the RTL description, and a path of the RTL description (critical path) is obtained from the results of the timing report. However, the relationship of correspondence with the behavioral description may readily be taken for any optional paths of the RTL description.

### Second Embodiment

The relationship of correspondence between the RTL description and the behavioral description may also be taken in case the table of correspondence between the inputs or the outputs to the nodes of the RTL description and the behavioral description is prepared in lieu of the table of correspondence between the nodes of the RTL description and the behavioral description. The following describes the sequence of operations of this second embodiment, in which the correspondence between the inputs or the outputs to the nodes of the RTL description and the behavioral description, is taken by way of taking the correspondence between the RTL description and the behavioral description, as in the above-described first embodiment. It is assumed for convenience of description that, in the present second embodiment, as in the above-described first embodiment, the RTL description of the configuration shown in FIG. 3 has already been obtained from the behavioral description of FIG. 2 through the stage of the CDFG shown in FIG. 3.

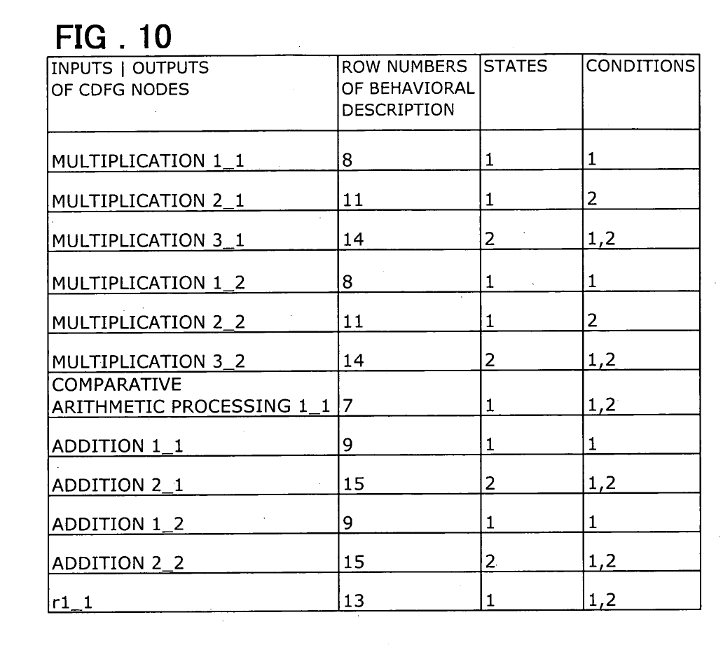

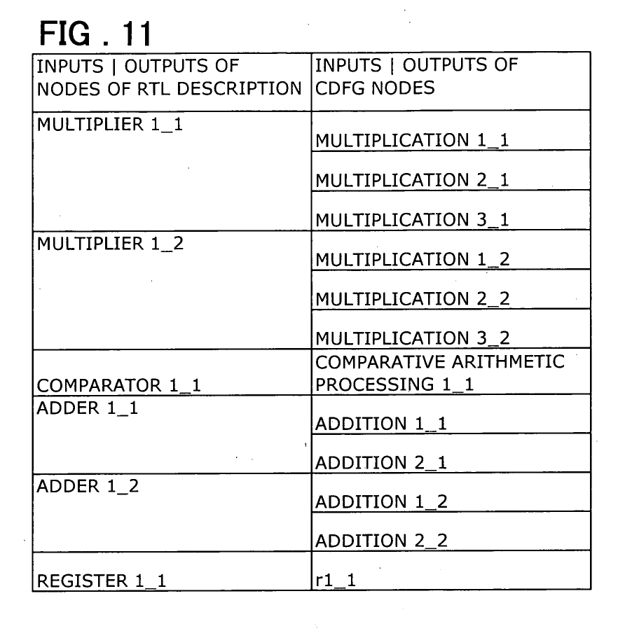

Initially, a behavioral synthesis device generates, at the time of the behavioral synthesis, the aforementioned tables (first and second tables of correspondence), at the steps S3 and S6 of FIG. 1. In this case, the behavior synthesis device directs attention not to the nodes of the RTL description or the CDFG, but to inputs or outputs of the respective nodes, to form the tables of correspondence between the inputs or outputs of the nodes and the behavioral description, as shown in FIGS. 10 and 11.

As in the above-described first embodiment, the path reflecting device combines the first and second tables of correspondence, with the node inputs or outputs of the CDFG as coupling key, to form a table of correspondence (third table of correspondence).

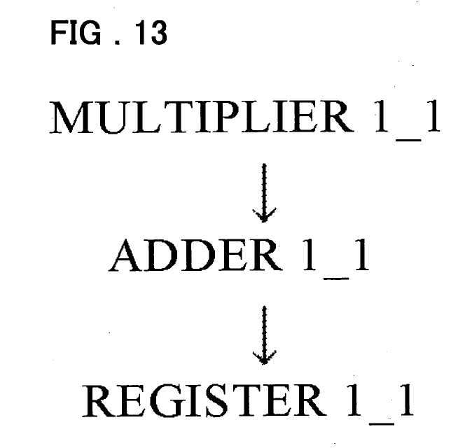

Next, the path reflecting device (circuit designing assisting device) executes static timing analysis to acquire the path information in the gate description from a timing report, as in the embodiment described above. A path of the RTL description is then obtained, using a method described in connection with the background art, or using an FDA tool. FIG. 13 shows the path of FIG. 8 in terms of inputs or outputs of the nodes of the RTL description.

Analysis of the states and the conditions of the path of FIG. 13 yields the same results as those of the above-described first embodiment. That is, it may be seen that the adder, multiplier and the register correspond to the rows 8, 9 and 13 of the behavioral description, respectively. Hence, a path on the RTL description can be determined on the behavioral description using this method of employing the table of correspondence to the inputs or outputs of the nodes in the RTL description.

Although preferred embodiments of the present invention are shown and described in the foregoing, the technical scope of the present invention is not to be limited to the embodiments described. As may be apparent from the principle of the present invention, a variety of changes or substitutions may be attempted without departing from the purport of the invention which resides in exploiting the information generated in the process of behavioral synthesis to render it possible to determine the sites of the behavioral description corresponding to the RTL description. It is to be noted that the above explanation, behavioral description in the respective figures, RTL description or the CDFG are given only for aiding in the understanding of the present invention.

The entire disclosure set forth in the appended claims is incorporated herein by reference thereto as part of the specification and the disclosure.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A behavioral synthesis device, said device receiving a behavioral description including at least one conditional branch sentence and synthesis constraints to generate a register transfer level description, including the state of finite state machine, from said behavioral description and synthesis constraints; said device comprising:
a storage unit for storing and holding the relationship of correspondence prevailing in the process of generating said register transfer level description among the description on a side of the behavioral description, description on a side of the register transfer level description, the state of the finite state machine and conditional branching in the behavioral description; and
a table of correspondence generating unit that generates, using the information stored and held in said storage unit, a table of correspondence showing at least the relationship of correspondence among said description on the side of the register transfer level description, said state of the finite state machine, the information on conditional branching and the description on the side of the behavioral description.

2. The behavioral synthesis device according to claim 1 wherein
said table of correspondence generating unit generates, when said behavioral synthesis device generates an intermediate level description from the behavioral description, a first table of correspondence which correlates at least nodes of the intermediate level description and corresponding portions of said behavioral description, using the information stored and held in said storage unit; and wherein
said table of correspondence generating unit generates, when said behavioral synthesis device generates register transfer level description including the state of the finite state machine from said intermediate level description and the synthesis constraints, a second table of correspondence which correlates at least nodes of the register transfer level description with nodes of said intermediate level description by the states of said finite state machine and the information on the conditional branching possessed by said intermediate level description.

3. The behavioral synthesis device according to claim 1 wherein
said table of correspondence generating unit generates, when said behavioral synthesis device generates intermediate level description from the behavioral description, a first table of correspondence which correlates at least input/output signals from nodes of the intermediate level description and corresponding portions of said behavioral description, using the information stored and held in said storage unit; and wherein
said table of correspondence generating unit generates, when said behavioral synthesis device generates the register transfer level description including the state of the finite state machine from said intermediate level description and the synthesis constraints, a second table of correspondence which correlates at least input/output signals of the nodes of the register transfer level description with input/output signals of the nodes of said intermediate level description by the state of said finite state machine and the information on the conditional branching possessed by said intermediate level description.

4. A circuit designing assisting device comprising:
a correspondence determining unit receiving the table of correspondence generated by the behavioral synthesis device according to claim 1 to output the relationship of correspondence between the register transfer level description and the behavioral description in such a manner as to render it possible to determine the relationship of correspondence by the state of the finite state machine possessed by said register transfer level description and by the information of the conditional branching in said behavioral description.

5. A circuit designing assisting device comprising:
a further table of correspondence generating unit that generates a third table of correspondence by synthesizing said first and second tables of correspondence, generated by said behavior synthesis device according to claim 2; and
a correspondence determining unit that outputs the relationship of correspondence between the register transfer level description and the behavioral description in such a manner as to render it possible to determine said relationship of correspondence with the aid of said third table of correspondence, by the state of the finite state machine possessed by said register transfer level description and by the information of the conditional branching in said behavioral description.

6. The circuit designing assisting device according to claim 4 wherein said correspondence determining unit receives path information by said register transfer level description;
extracts a source row or rows of the behavioral description by which a path specified by said path information, in its entirety, comes to belong to the same state of the finite state machine and to the same conditional branch; and
outputs the source row or rows of said behavioral description extracted.

7. A program executed by a computer receiving the behavioral description including at least one conditional branch sentence and synthesis constraints to generate register transfer level description, including the state of a finite state machine, from said behavioral description and the synthesis constraints; said program allowing said computer to execute the following steps comprising:
processing for generating an intermediate level description having states of said finite state machine and conditional branching in said behavioral description, based on the behavioral description and synthesis constraints, for generating a first table of correspondence correlating at least the nodes of said intermediate level description to corresponding portions of said behavioral description, and for storing said intermediate level description and the first table of correspondence in intermediate level description storage means and in first table of correspondence storage means; and
RTL generating processing for generating register transfer level description including the state of the finite state machine, based on the intermediate level description stored in said intermediate level description storage means and said synthesis constraints, for generating a second table of correspondence correlating at least nodes of said register transfer level description to nodes of said intermediate level description by the states of said finite state machine and the information on said conditional branching, possessed by said intermediate level description, and for storing said register transfer level description and the intermediate level description in a register transfer level description storage unit and in a second table of correspondence storage unit, respectively.

8. A program for allowing a computer forming a circuit designing assisting device to execute the processing of receiving the table of correspondence, generated by the behavioral synthesis device, according to claim 1, and of determining the relationship of correspondence between the register transfer level description and the behavioral description by the state of the finite state machine possessed by said register transfer level description and by the information on the conditional branching possessed by said behavioral description.

9. A program for allowing a computer forming a circuit designing assisting device to execute the following steps comprising:
generating a third table of correspondence by synthesizing the first and second tables of correspondence generated by the behavioral synthesis device according to claim 2, and
determining the relationship of correspondence between the register transfer level description and the behavioral description with use of said third table of correspondence, by the state of the finite state machine possessed by said register transfer level description and by the information on the conditional branching possessed by said behavioral description.

10. The program according to claim 8 for allowing a computer constituting a circuit designing assisting device to execute the following processing comprising:
receiving path information based on said register transfer level description;
extracting a source row or rows of the behavioral description by which a path specified by said path information, in its entirety, comes to belong to the same state of the finite state machine and to the same conditional branch; and
outputting the source row or rows of said behavioral description extracted.

11. A method for determining the relationship of correspondence between the register transfer level description and the behavioral description, carried out using a behavioral synthesis device and a circuit designing assisting device, said behavioral synthesis device generating, from the behavioral description having a conditional branching sentence, and from synthesis constraint, the register transfer level description including the state of a finite state machine, comprising:
a step of said behavioral synthesis device storing and holding the relationship among the description on the side of the behavioral description, the description on the side of the register transfer level description, the state of the finite state machine, and the conditional branching in said behavioral description, in a relationship of correspondence storage unit;
a step of said behavioral synthesis device, generating a table of correspondence showing at least the description on the side of the register, the state of the finite state machine, the information on said conditional branching and the description on the side of the behavioral description, using the information stored and held in said relationship of correspondence storage unit; and
a step of said circuit designing assisting device outputting the relationship of correspondence between the register transfer level description and the behavioral description so that said relationship of correspondence will be uniquely determined by the state of said finite state machine and by the information on said conditional branching.

12. The method for determining the relationship of correspondence between the register transfer level description and the behavioral description according to claim 11, wherein
said behavioral synthesis device generates, upon generating the intermediate level description from said behavioral description, a first table of correspondence which correlates at least nodes of the intermediate level description and corresponding portions of the behavioral description, using information stored and held in said storage unit;
said behavioral synthesis device generates, upon generating said register transfer level description including the state of the finite state machine from the intermediate level description and synthesis constraint, a second table of correspondence which correlates at least input/output signals from nodes of the register transfer level description and input/output signals from nodes of the intermediate level description, by the state of the finite state machine and the information on conditional branching, possessed by said intermediate level description, using the information stored and held by said storage unit;
said circuit designing assisting device generating a third table of correspondence by synthesizing said first and second tables of correspondence and outputting the relationship of correspondence between said register transfer level description and the behavioral description, with the aid of said third table of correspondence, so that said relationship of correspondence will be uniquely determined by the state of said finite state machine and said information on said conditional branching.

13. The method for determining the relationship of correspondence between the register transfer level description according to claim 11, wherein
said behavioral synthesis device generates, upon generating the intermediate level description from said behavioral description, the first table of correspondence which correlates at least input/output signals from nodes of the register transfer level description with input/output signals from nodes of the intermediate level description and corresponding portions of the behavioral description, using the information stored and held in said storage unit; and wherein
said behavioral synthesis device generates, upon generating said register transfer level description including the state of the finite state machine from the intermediate level description and the synthesis constraint, a second table of correspondence which correlates at least input/output signals from the nodes of the register transfer level description and the input/output signals from the nodes of the intermediate level description by the state of the finite state machine and the information on the conditional branching, possessed by said intermediate level description, using the information stored and held by said storage unit;
said circuit designing assisting device generating a third table of correspondence by synthesizing said first and second tables of correspondence and outputting the relationship of correspondence between said register transfer level description and the behavioral description, with the aid of said third table of correspondence, so that said relationship of correspondence will be uniquely determined by the state of said finite state machine and said information on said conditional branching.

14. A method for determining the relationship of correspondence between the register transfer level description according to claim 12 further comprising:
a step of said circuit designing assisting device receiving the path information by said register transfer level description;
a step of said circuit designing assisting device extracting, from said third table of correspondence, a source row or rows of the behavioral description by which a path specified by said path information, in its entirety, comes to belong to the same state of the finite state machine and to the same conditional branch; and
a step of said circuit designing assisting device outputting the source row or rows of said behavioral description extracted.
